(19) United States
(12) Patent Application Publication
(10) Pub. No.: US 2020/0359750 A1
(43) Pub. Date: Nov. 19, 2020

(54) TONGUE

(71) Applicant: Joyson Safety Systems Japan K.K., Tokyo (JP)

(72) Inventors: Hodaka INISHI, Shiga (JP); Hirotaka KATO, Shiga (JP)

(21) Appl. No.: 16/618,442

(22) PCT Filed: May 31, 2018
(86) PCT No.: PCT/JP2018/020983

§ 371 Date: Dec. 2, 2019

(30) Foreign Application Priority Data
Jun. 7, 2017 (JP) 2017-112839

(51) Int. Cl. A44B 11/25; B60R 22/18

(52) U.S. Cl. CPC A44B 11/2561; B60R 2022/1812; B60R 22/18; A44B 11/2553

(57) ABSTRACT

A tongue (7) includes a plate (20) having a longitudinal portion (21) that is insertable into a buckle (8), and a broader portion (22) that is located on an opposite side from a tip end (24) of the longitudinal portion (21) and is formed wider than the longitudinal portion (21). The broader portion (22) is covered at least in part. The broader portion (22) has a base (23) that is connected to the longitudinal portion (21), a beam (25) that extends in a long-side direction of the broader portion (22), a connecting portion (39) that connects the base (23) to the beam (25), and a through hole (71) that is defined by the base (23), the beam (25), and the connecting portion (39) and through which a seat belt is inserted. An edge, located at the side portion (35, 36) of the beam (25) forming the through hole (71), is subjected to a beveling press or is chamfered. The edge faces one side of the seat belt (4) passing through the through hole to a shoulder anchor (6).

### TECHNICAL FIELD

The disclosures herein relate to a tongue for a seat belt apparatus.

### BACKGROUND ART

Conventionally, there is a need for downsizing a tongue for a seat belt apparatus. For example, the overall length of a tongue can be reduced by reducing the size of a through hole through which a seat belt is inserted.

When a seat belt is not worn, the seat belt is positioned at the side of a seat and extends downward from a shoulder anchor located above. At this time, a tongue is suspended from the seat belt. If the through hole is small, the inclination angle of the tongue with respect to the seat belt becomes large. As a result, projection of the tongue from the seat belt increases and the tongue may become obstructive when the seat belt is not worn.

In order to solve the above-described problem, Patent Document 1 describes a configuration in which the inclination angle of a tongue with respect to a seat belt is reduced by bending and inclining an edge portion of a through hole.

### RELATED-ART DOCUMENTS

### Patent Documents

Patent Document 1: U.S. Pat. No. 7,761,960

### SUMMARY OF THE INVENTION

### Problem to be Solved by the Invention

However, in the configuration described in Patent Document 1, although the inclination angle of the tongue is reduced, the edge portion of the through hole protrudes in the thickness direction of the tongue. As a result, the thickness of the tongue increases, thereby making it difficult to reduce the size of the tongue.

It is an object of the present disclosure to provide a tongue that can be downsized by reducing the inclination angle of the tongue with respect to a seat belt when the seat belt is not worn.

### Means to Solve the Problem

According to one embodiment of the present invention, a tongue includes a plate having a longitudinal portion that is insertable into a buckle, and a broader portion that is located on an opposite side from a tip end of the longitudinal portion and is formed wider than the longitudinal portion. The broader portion is covered at least in part. The broader portion has a base that is connected to the longitudinal portion, a beam that extends in a long-side direction of the broader portion, a connecting portion that connects the base to the beam, and a through hole that is defined by the base, the beam, and the connecting portion and through which a seat belt is inserted. An edge, located at the side portion of the beam forming the through hole, is subjected to a beveling press or is chamfered. The edge faces one side of the seat belt passing through the through hole to a shoulder anchor.

### Effects of the Invention

According to the present disclosure herein, it is possible to provide a tongue that can be downsized by reducing the inclination angle of the tongue with respect to a seat belt when the seat belt is not worn.

### BRIEF DESCRIPTION OF THE DRAWINGS

FIG. 1 is a drawing illustrating an example of a seat belt apparatus that includes a tongue according to a first embodiment;

FIG. 2 is a perspective view of the tongue of FIG. 1;

FIG. 3 is a plan view of a plate of FIG. 2;

FIG. 4 is a cross-sectional view of the plate taken through A-A of FIG. 3;

FIG. 5 is a comparative example illustrating a cross-sectional view of a plate having a beam with no inclined surface;

FIG. 6 is a cross-sectional view of a plate of a tongue according to a second embodiment; and

FIG. 7 is a cross-sectional view of a plate of a tongue according to a third embodiment.

### MODE FOR CARRYING OUT THE INVENTION

In the following, embodiments of the present invention will be described with reference to the accompanying drawings. For convenience of explanation, the same elements are denoted by the same reference numerals in the drawings, and a duplicate description thereof will be omitted.

### First Embodiment

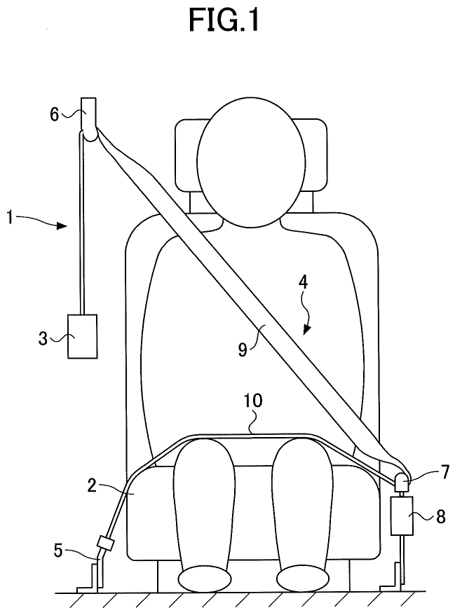

Referring to FIG. 1 through FIG. 5, a first embodiment will be described. FIG. 1 is a drawing illustrating an example of a seat belt apparatus 1 that includes a tongue 7 according to the first embodiment. The seat belt apparatus 1 includes a seat belt 4, a retractor 3, a shoulder anchor 6, a tongue 7, and a buckle 8.

The seat belt 4 is an example of webbing for restraining an occupant sitting on a seat 2 of a vehicle. The seat belt 4 is a band-shaped member that can be retracted into and extended from the retractor 3. A belt anchor 5 located at the end of the seat belt 4 is fixed to the vehicle floor or to the seat 2.

The retractor 3 is an example of a winding device that allows the seat belt 4 to be retracted and extended. When the vehicle undergoes deceleration greater than or equal to a predetermined value due to an accident such as a vehicle collision, the retractor 3 restricts the seat belt 4 from being pulled out of the retractor 3. The retractor 3 is fixed to the seat 2 or to the vehicle body near the seat 2.

The shoulder anchor 6 is an example of a seat belt insertion member through which the seat belt 4 is inserted. The shoulder anchor 6 serves to guide the seat belt 4 toward the shoulder of the occupant when the seat belt 4 is pulled out of the retractor 3.

The tongue 7 is an example of a seat-belt insertion member through which the seat belt 4 is inserted. The tongue 7 is slidably attached to the seat belt 4 that is guided by the shoulder anchor 6.

The buckle 8 is an example of a member with which the tongue 7 is removably engaged. The buckle 8 is fixed to the vehicle floor or to the seat 2.

A shoulder belt 9 is a part of the seat belt 4 located between the shoulder anchor 6 and the tongue 7 when the tongue 7 is engaged with the buckle 8. The shoulder belt 9 restrains the chest and the shoulder of the occupant. A lap belt 10 is a part of the seat belt 4 located between the belt anchor 5 and the tongue 7 when the tongue 7 is engaged with the buckle 8. The lap belt 10 restrains the waist of the occupant.

In a non-wearing state in which the seat belt 4 is not worn by the occupant, the tongue 7 is not engaged with the buckle 8 and the seat belt 4 is entirely retracted into the retractor 3 (i.e., to the full extent that the seat belt 4 can be smoothly retracted into the retractor 3). Conversely, in a wearing state in which the seat belt 4 is worn by the occupant, the seat belt 4 is pulled out of the retractor 3 as illustrated in FIG. 1. Further, the tongue 7 is engaged with the buckle 8 and the seat belt 4 is pulled back into the retractor 3 such that slackness of the seat belt 4 becomes small. In this way, the seat belt 4 is worn by the occupant.

When the vehicle does not undergo deceleration greater than or equal to the predetermined value due to a vehicle collision in a state in which the tongue 7 is engaged with the buckle 8 and the seat belt 4 is worn by the occupant, the seat belt 4 can be freely pulled out of the retractor 3 at a normal pulling-out speed. Once pulling force in a pulling direction of the seat belt 4 is released, the excessive length of the seat belt 4 is pulled back into the retractor 3.

When the vehicle undergoes deceleration greater than or equal to the predetermined value due to an emergency situation such as a vehicle collision in a state in which the tongue 7 is engaged with the buckle 8 and the seat belt 4 is worn by the occupant, the retractor 3 locks or retracts the seat belt 4 so as to restrict the seat belt 4 from being pulled out of the retractor 3. Accordingly, the seat belt 4 can securely restrain the occupant.

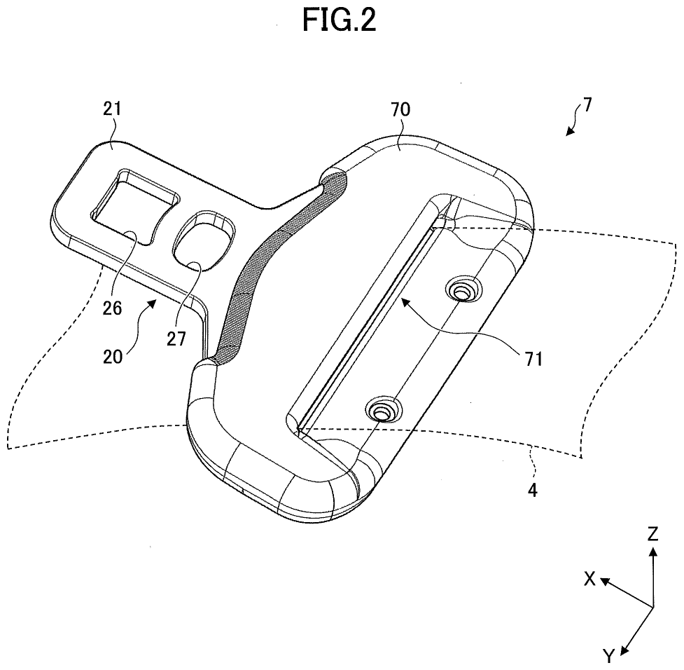

FIG. 2 is a perspective view of the tongue 7 of FIG. 1. As illustrated in FIG. 2, the tongue 7 has a through hole 71 through which the seat belt 4 is inserted. Further, the tongue 7 has a plate 20 made of metal. A part of the plate 20 is covered by a mold 70 formed of a resin, for example.

In FIG. 2 and the subsequent figures, the X-direction, the Y-direction, and the Z-direction are perpendicular to each other. The X-direction is an extending direction of a longitudinal portion 21. The Y-direction is an extending direction of a broader portion 22 of the plate 20. The Z-direction is a direction in which a pair of main surfaces 72 and 73 is opposite to each other and is also a direction perpendicular to the main surfaces 72 and 73.

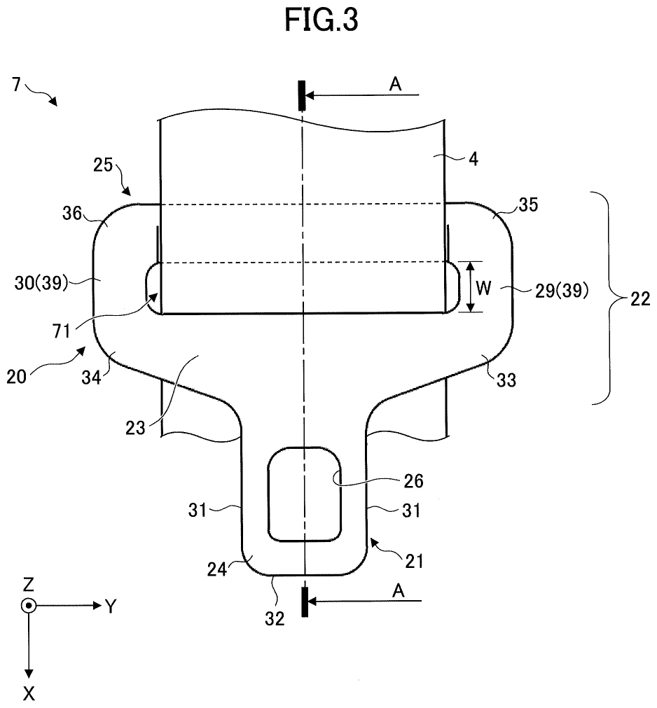

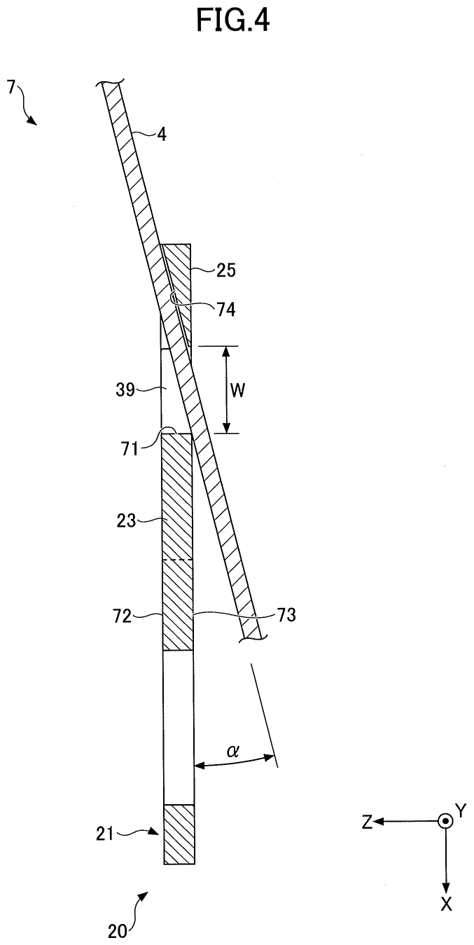

FIG. 3 is a plan view of the plate 20 of FIG. 2. FIG. 4 is a cross-sectional view of the plate 20 taken through A-A of FIG. 3. As illustrated in FIG. 3 and FIG. 4, the plate 20 includes the longitudinal portion 21 that can be inserted into the buckle 8, and also includes the broader portion 22 that is formed wider than the longitudinal portion 21. The plate 20 is a planar plate-shaped member formed in a substantially T-shape. By inserting the longitudinal portion 21 into the buckle 8, the tongue 7 is coupled to the buckle 8 via the plate 20.

The plate 20 is formed by stamping from a single metal plate containing carbon steel as a main component. The plate 20 is the plate-shaped member having the pair of main surfaces 72 and 73.

The longitudinal portion 21 is a planar plate portion that can be engaged with the buckle 8. The longitudinal portion 21 extends from the broader portion 22 to a tip end 24 in the positive X-direction. The X-direction corresponds to a longitudinal direction of the longitudinal portion 21. The longitudinal portion 21 has a pair of long sides 31 and one short side 32. The pair of long sides 31 is an outer edge extending from the broader portion 22 in the positive X-direction. The short side 32 is an outer edge extending in a short-length direction of the longitudinal portion 21 (the y-direction), and is also an outer edge of the tip end 24 in the X-direction. The Y-direction corresponds to a width direction of the longitudinal portion 21.

The longitudinal portion 21 has a latch hole 26 between the tip end 24 and the broader portion 22. The latch hole 26 is engaged with a latch member of the buckle 8. The longitudinal portion 21 may have a lightening hole 27 (see FIG. 2) between the tip end 24 and the broader portion 22. The lightening hole 27 makes the plate 20 lightweight. Note that the lightening hole 27 is not depicted in FIG. 3 and the subsequent figures.

The broader portion 22 is a plate portion located on the opposite side from the tip end 24 of the longitudinal portion 21 in the X-direction. The long-side direction of the broader portion 22 corresponds to the Y-direction. The broader portion 22 has a base 23, a beam 25, and a connecting portion 39.

The base 23 is connected to a root end located on the opposite side from the tip end 24 of the longitudinal portion 21 in the X-direction. The base 23 is a planar plate portion that is formed wider than the longitudinal portion 21. The longitudinal direction of the base 23 corresponds to the Y-direction. The base 23 has a first side end 33 and a second side end 34. The first side end 33 is one side end in the Y-direction, and the second side end 34 is the other side end on the opposite side of the first side end 33 in the Y-direction.

The beam 25 is a planar plate portion extending in the long-side direction of the broader portion 22 (namely, in the Y-direction). The longitudinal direction of the beam 25 corresponds to the Y-direction. The beam 25 has a first beam end 35 and a second beam end 36. The first beam end 35 is one beam end in the Y-direction, and the second beam end 36 is the other beam end on the opposite side of the first beam end 35 in the Y-direction.

The connecting portion 39 is a planar plate portion that connects the base 23 to the beam 25. The connecting portion 39 has a first arm 29 and a second arm 30. The first arm 29 is a connecting portion that connects the first side end 33 to the first beam end 35. The second arm 30 is a connecting portion that connects the second side end 34 to the second beam end 36.

In the plate 20, the through hole 71 is defined by the base 23, the beam 25, and the connecting portion 39 of the broader portion 22. More specifically, the through hole 71 is defined by continuously connecting an edge on a negative X-side of the base 23, an edge on a positive X-side of the beam 25, an edge on a negative Y-side of the first arm 29 of the connecting portion 39, and an edge on a positive Y-side of the second arm 30 of the connecting portion 39. The through hole 71 has an approximately rectangular shape, with the longer side being in the Y-direction and the shorter side being in the X-direction.

In the present embodiment, the seat belt 4 is inserted through the through hole 71 such that the part of the seat belt 4 extending to the shoulder anchor 6 faces the one main surface 72, and the part of the seat belt 4 extending to the belt anchor 5 faces the other main surface 73 of the plate 20.

As described, when the occupant does not wear the seat belt, the seat belt 4 is positioned at the side of the seat and extends downward from the shoulder anchor 6 located above. In the example of FIG. 1, the seat belt 4 is positioned at the left side (of the figure) of the seat 2 and extends linearly in the top-bottom direction between the shoulder anchor 6 and the belt anchor 5 located vertically downward. At this time, the tongue 7 is suspended from the seat belt 4 between the shoulder anchor 6 and the belt anchor 5 while being inclined. Namely, as illustrated in FIG. 3 and FIG. 4, when the seat belt 4 is not worn, the part of the seat belt 4 facing the one main surface 72 of the plate 20 extends upward from the through hole 71 to the shoulder anchor 6, and the part of the seat belt 4 facing the other main surface 73 extends downward from the through hole 71 to the belt anchor 5.

By considering the above-described positional relationship between the tongue 7 and the seat belt 4 when the seat belt 4 is not worn, in the first embodiment, at the side portion on the positive X-side of the beam 25 forming the through hole 71, the edge of the beam 25 facing the part of the seat belt 4 extending through the through hole 71 to the shoulder anchor 6 is subjected to a beveling press, as illustrated in FIG. 4. More specifically, the side portion on the positive X-side of the beam 25 has an inclined surface 74 on the main surface 72 side. The inclined surface 74 is inclined in the negative Z-direction relative to the positive X-direction. The inclined surface 74 is formed over the entire width in the Y-direction at the side portion of the beam 25 forming the through hole 71. Further, on the main surface 73 on the opposite side from the main surface 72 having the inclined surface 74, the side portion on the positive X-side of the beam 25 does not protrude in the negative Z-direction and is flat along the main surface 73.

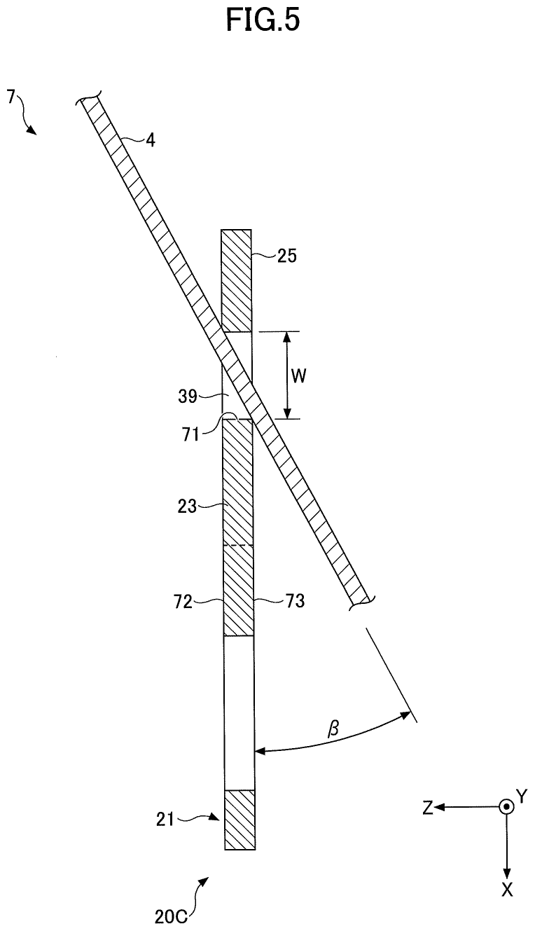

As illustrated in FIG. 4, α represents the inclination angle of the tongue 7 with respect to the seat belt 4 when the seat belt is not worn. FIG. is a comparative example illustrating a cross-sectional view of a plate 20C having the beam 25 with no inclined surface 74. The position of the cross section of FIG. 5 is the same as that of FIG. 4. As illustrated in FIG. 5, β represents the inclination angle of the tongue 7 with respect to the seat belt 4 when the seat belt 4 is not worn in the comparative example.

In the comparative example as illustrated in FIG. 5, the beam 25 of the plate 20C has no inclined surface 74. Thus, the position where the beam 25 contacts the seat belt 4 shifts in the positive Z-direction, resulting in the inclination angle β of the tongue 7 with respect to the seat belt 4 to be relatively large as compared to the inclination angle α illustrated in FIG. 4 according to the present embodiment. This tendency becomes more pronounced as a dimension W in the X direction of the through hole 71 is reduced in order to reduce the size of the tongue 7 by reducing the overall length in the X direction of the tongue 7. That is, as the dimension W in the X-direction of the through hole 71 decreases, the inclination angle β of the tongue 7 increases.

Conversely, in the tongue 7 according to the first embodiment, the beam 25 of the plate 20 has the inclined surface 74 as illustrated in FIG. 4. Thus, the position where the beam 25 contacts the seat belt 4 can be moved in the negative Z-direction. As a result, the inclination angle α of the tongue 7 with respect to the seat belt 4 can be reduced when the seat belt 4 is not worn.

Further, even when the dimension W in the X-direction of the through hole 71 is reduced in order to reduce the size of the tongue 7, the inclination angle α of the tongue 7 can be set to a desired angle by appropriately adjusting the angle of the inclined surface 74. Further, the inclined surface 74 is formed by being subjected to a beveling press. Therefore, even if the beam 25 has the inclined surface 74 on the one main surface 72 side, the beam 25 would not protrude to the other main surface 73 side. Accordingly, it is possible to reduce the overall length in the X-direction while also preventing an increase in the thickness of the tongue 7 in the Z-direction, thus allowing the size of the tongue 7 to be readily reduced. According to the first embodiment, the inclination angle α of the tongue 7 with respect to the seat belt 4 when the seat belt 4 is not worn can be reduced, and the size of the tongue 7 can be thus reduced.

### Second Embodiment

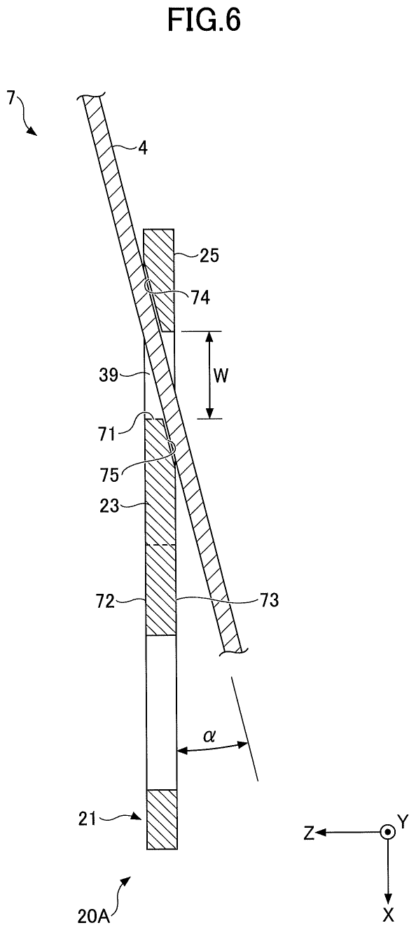

Referring to FIG. 6, a second embodiment will be described. FIG. 6 is a cross-sectional view of a plate 20A of a tongue 7 according to the second embodiment. The position of the cross section of FIG. 6 is the same as that of FIG. 4.

As illustrated in FIG. 6, the second embodiment differs from the first embodiment in that, in addition to the inclined surface 74 provided on the beam 25 of the plate 20A, the base 23 of the plate 20A has an inclined surface 75.

As illustrated in FIG. 6, at the side portion on the negative X-side of the base 23 forming the through hole 71, the edge of the base 23, facing the part of the seat belt 4 in the non-wearing state in which the seat belt 4 inserted through the through hole 71 is not worn by the occupant, is subjected to a beveling press. More specifically, the side portion on the negative X-side of the base 23 has the inclined surface 75 on the main surface 73 side. The inclined surface 75 is inclined in the positive Z-direction relative to the negative X-direction. The inclined surface 75 is formed over the entire width in the Y-direction at the side portion of the base 23 forming the through hole 71. Further, on the main surface 72 on the opposite side from the main surface 73 having the inclined surface 75, the side portion on the negative X-side of the base 23 does not protrude in the positive Z-direction and is flat along the main surface 72.

As described above, in the second embodiment, the base 23 of the plate 20A has the inclined surface 75. Therefore, the position where the base 23 contacts the seat belt 4 can be moved further to the positive Z-side than that of the first embodiment. Accordingly, the inclination angle α of the tongue 7 with respect to the seat belt 4 when the seat belt 4 is not worn can be further reduced. While the inclination angle α of the tongue 7 is reduced by the single inclined surface 74 in the first embodiment, the inclination angle α of the tongue 7 is reduced by the two inclined surfaces 74 and 75 in the second embodiment, as illustrated in FIG. 6. Accordingly, in order to set the inclination angle α of the tongue 7 to the same angle as the first embodiment, the two inclined surfaces 74 and 75 can be utilized to reduce the inclination angle α. Therefore, the amount of a beveling press of each of the inclined surfaces 74 and 75 can be reduced, thus making the process easier.

Further, even when the dimension W in the X-direction of the through hole 71 is reduced in order to reduce the size of the tongue 7, the inclination angle α of the tongue 7 can be set to a desired angle by appropriately adjusting the angle of the inclined surfaces 74 and 75. Further, the inclined surface 74 is formed by being subjected to a beveling press. Therefore, even if the beam 25 has the inclined surface 74 on the one main surface 72 side, the beam 25 would not protrude to the other main surface 73 side. Similarly, the inclined surface 75 is formed by being subjected to a beveling press. Therefore, even if the base 23 has the inclined surface 75 on the main surface 73 side, the base 23 would not protrude to the main surface 72 side. Accordingly, it is possible to reduce the overall length in the X-direction while also preventing an increase in the thickness of the tongue 7 in the Z-direction, thus allowing the size of the tongue 7 to be readily reduced. According to the second embodiment, the inclination angle α of the tongue 7 with respect to the seat belt 4 when the seat belt 4 is not worn can be reduced, and the size of the tongue 7 can be thus reduced.

### Third Embodiment

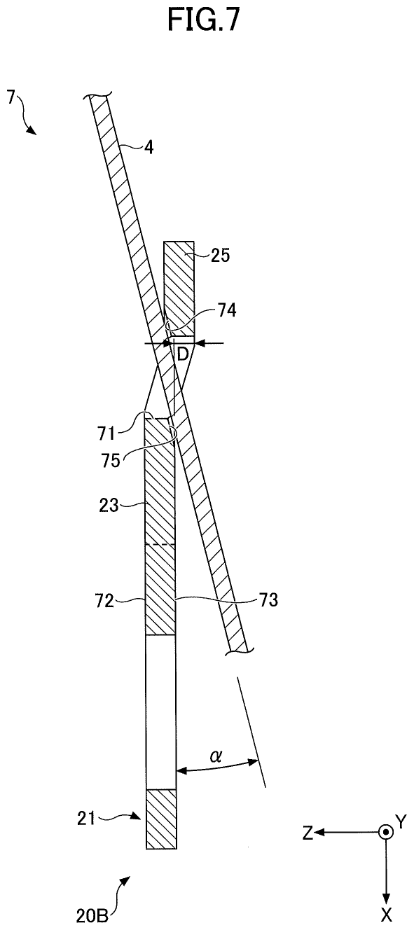

Referring to FIG. 7, a third embodiment will be described. FIG. 7 is a cross-sectional view of a plate 20B of a tongue 7 according to the third embodiment. The position of the cross section of FIG. 7 is the same as that of FIG. 4.

As illustrated in FIG. 7, the third embodiment differs from the second embodiment in that, the beam 25 of the plate 20B is offset to the side opposite to the edge of the beam 25 that is subjected to a beveling press, in a direction (namely, in the negative Z-direction) perpendicular to the extending direction of the longitudinal portion 21 and to the extending direction of the broader portion 22.

For example, by bending a connecting portion 39 of the plate 20B in the negative Z-direction, the beam 25 can be offset with respect to the base 23 in the negative Z-direction, as illustrated in FIG. 7.

In this manner, by offsetting the beam 25 of the plate 20B, the position where the beam 25 contacts the seat belt 4 can be moved further in the negative Z-direction than those of the first and second embodiments. Accordingly, the inclination angle α of the tongue 7 with respect to the seat belt 4 when the seat belt 4 is not worn can be further reduced. In order to set the inclination angle α to the same angle as that of the first and second embodiments, the offset amount D may be increased. Therefore, the amount of a beveling press of each of the inclined surfaces 74 and 75 can be reduced, thus making the process easier.

In the configuration of the first embodiment in which the base 23 has no inclined surface 75, the beam 25 may be offset, similar to the third embodiment.

Although specific embodiments have been described above, the present disclosure is not limited to the above-described embodiments. These described embodiments may be modified by a person skilled in the art as long as the features of the present disclosure are included. The arrangement, conditions, and shapes of the structural elements as described in the embodiments are not limited to the arrangement, conditions, and shapes as described, and may be modified as necessary. It should be noted that combination of the elements of the above-described embodiments may be changed as long as no technical contradiction occurs.

In the above-described embodiments, the inclined surface 74 provided on the beam 25 of each of the plate 20, the plate 20A, and the plate 20B, and the inclined surface 75 provided on the base 23 of each of the plate 20A and the plate 20B are formed by being subjected to a beveling press. However, the inclined surface 74 and the inclined surface 75 may be formed by being chamfered. Further, in the above-described embodiments, the inclined surfaces 74 and 75 are formed in a planar shape; however, the inclined surfaces 74 and 75 may be formed in other shapes such as a curved shape.

The present application is based on and claims priority to Japanese patent application No. 2017-112839 filed on Jun. 7, 2017, with the Japanese Patent Office, the entire contents of which are hereby incorporated by reference.

### DESCRIPTION OF REFERENCE SYMBOLS

1 seat belt apparatus
4 seat belt
6 shoulder anchor
7 tongue
8 buckle
20, 20A, 20B plates
21 longitudinal portion
22 broader portion
23 base
25 beam
39 connecting portion
71 through hole
74, 75 inclined surfaces

1. A tongue comprising,
a plate having a longitudinal portion that is insertable into a buckle, and a broader portion that is located on an opposite side from a tip end of the longitudinal portion and is formed wider than the longitudinal portion, the broader portion being covered at least in part,
wherein the broader portion has a base that is connected to the longitudinal portion, a beam that extends in a long-side direction of the broader portion, a connecting portion that connects the base to the beam, and a through hole that is defined by the base, the beam, and the connecting portion and through which a seat belt is inserted, and
an edge, located at a side portion of the beam forming the through hole, is subjected to a beveling press or is chamfered, the edge facing one side of the seat belt passing through the through hole to a shoulder anchor.

2. The tongue according to claim 1, wherein an edge, located at a side portion of the base forming the through hole, is subjected to a beveling press or is chamfered, the edge facing another side of the seat belt in a non-wearing state in which the seat belt passing through the through hole is not worn by an occupant.

3. The tongue according to claim 1, wherein the beam is offset to a side opposite to the edge that is subjected to the beveling press or is chamfered, in a direction perpendicular to an extending direction of the longitudinal portion and to an extending direction of the broader portion.
